(19) United States
(12) Patent Application Publication
(10) Pub. No.: US 2026/0228812 A1
(43) Pub. Date: Aug. 6, 2026

(54) CAR SHARING SYSTEM AND GEOFENCE SETTING METHOD

(71) Applicant: TOYOTA JIDOSHA KABUSHIKI KAISHA, Toyota-shi (JP)

(72) Inventors: Ryosuke TANIMURA, Nagoya-sh (JP); Hiroki TAKEISHI, Machida-shi (JP); Reina YAMAMURA, Nagoya-shi (JP)

(73) Assignee: TOYOTA JIDOSHA KABUSHIKI KAISHA, Toyota-shi (JP)

(21) Appl. No.: 19/410,208

(22) Filed: Dec. 5, 2025

(30) Foreign Application Priority Data
Jan. 29, 2025 (JP) 2025-012798

(51) Int. Cl. G06Q 30/0645; G05D 1/229; G06Q 50/43

(52) U.S. Cl. CPC G06Q 30/0645; G05D 1/2295; G06Q 50/43

(57) ABSTRACT

A car sharing system includes: a position information acquisition device that acquires position information of a vehicle; a storage device that stores map information including three-dimensional data of a building positioned around a car station where the vehicle is rented out and returned; and a control device that sets a geofence being a returnable range of the vehicle and corresponding to the car station, in which the control device acquires the map information from the storage device, and executes control to expand the geofence, when an accuracy of the position information at the car station, the position information being acquired by the position information acquisition device, is estimated to be lower than a threshold value set in advance, based on the acquired map information, because the car station is surrounded, in a predetermined ratio, by the building with a height equal to or greater than a predetermined height.

### CROSS-REFERENCE TO RELATED APPLICATION

This application claims priority to Japanese Patent Application No. 2025-012798 filed on January 29, 2025. The disclosure of the above-identified application, including the specification, drawings, and claims, is incorporated by reference herein in its entirety.

### BACKGROUND

### Technical Field

The present disclosure relates to a car sharing system and a geofence setting method.

### Description of Related Art

Japanese Unexamined Patent Application Publication No. 2021-086170 (JP 2021-086170 A) discloses a car sharing service in which a vehicle (car sharing vehicle) that is jointly used among members registered in advance is rented out and returned at a car station. In such a car sharing service, for example, return determination to the car station is made at the time of return of the vehicle using position information of the vehicle acquired by a global positioning system (GPS). More specifically, for example, in the car sharing system, a geofence corresponding to the car station is manually set by an administrator, or the like. Then, based on the position information of the vehicle acquired by GPS, the return determination is made depending on whether the vehicle to be returned has entered the geofence.

### SUMMARY

However, since the setting of the geofence corresponding to the car station by the administrator is performed based on the administrator's experience or the like, the return determination of the vehicle may not be correctly made unless the geofence is appropriately set.

The present disclosure has been made in view of the problem described above, and an object thereof is to provide a car sharing system and a geofence setting method capable of appropriately setting a geofence corresponding to a car station.

In order to solve the above-described problem and to achieve the object, a car sharing system according to the present disclosure includes:

a position information acquisition device configured to acquire position information of a vehicle that is jointly used among users registered in advance;

a storage device configured to store map information including three-dimensional data of a building positioned around a car station where the vehicle is rented out and returned; and

a control device configured to set a geofence that is a returnable range of the vehicle and that corresponds to the car station in which the control device is configured to acquire the map information from the storage device, and is configured to execute control to expand the geofence.

When an accuracy of the position information at the car station, the position information being acquired by the position information acquisition device, is estimated to be lower than a threshold value set in advance, based on the map information that is acquired, because the car station is surrounded, in a predetermined ratio, by the building with a height equal to or greater than a predetermined height.

As a result, in the car sharing system according to the present disclosure, the geofence corresponding to the car station can be appropriately set such that the return of the vehicle by the user can be completed even in a case where the accuracy of the position information of the vehicle at the car station is low.

In addition, a geofence setting method according to the present disclosure includes:

estimating based on map information including three-dimensional data of a building positioned around a car station where a vehicle that is jointly used among users registered in advance is rented out and returned,

an accuracy of position information of the vehicle acquired by GPS at the car station, and expanding, when the accuracy of the position information is estimated to be lower than a threshold value set in advance, and

a geofence that is a returnable range of the vehicle and that corresponds to the car station.

As a result, in the geofence setting method according to the present disclosure, the geofence corresponding to the car station can be appropriately set such that the return of the vehicle by the user can be completed even in a case where the accuracy of the position information of the vehicle acquired by GPS at the car station is low.

In addition, a geofence setting method according to the present disclosure includes:

narrowing, when portions of a plurality of geofences overlap with each other, at least one of the geofences such that the geofences do not overlap with each other, the geofences being each a returnable range of a vehicle jointly used among users registered in advance and each corresponding to one of a plurality of car stations where the vehicle is rented out and returned.

As a result, in the geofence setting method according to the present disclosure, each of the geofences corresponding to one of the car stations can be appropriately set such that a situation in which the vehicle can be returned to the car station that is unintended by the user among the car stations is suppressed.

In addition, a geofence setting method according to the present disclosure includes:

collecting, after an operation of a car sharing service in which a vehicle is jointly used among users registered in advance is started, actual position information of the vehicle at a time of return of the vehicle, and expanding, when a variation in the position information is larger than a threshold value set in advance, a geofence that is a returnable range of the vehicle and that corresponds to a car station where the vehicle is returned.

As a result, in the geofence setting method according to the present disclosure, the geofence corresponding to the car station can be appropriately set such that the variation in the vehicle return position is small.

In addition, a geofence setting method according to the present disclosure includes:

narrowing, when determination is made that a vehicle that is jointly used among users registered in advance is returned to a car station where the vehicle is rented out and returned even though an actual vehicle return position at a time of return of the vehicle is a position other than the car station, a geofence that is a returnable range of the vehicle and that corresponds to the car station such that the vehicle return position is not included.

As a result, in the geofence setting method according to the present disclosure, the geofence corresponding to the car station can be appropriately set such that a situation in which the vehicle can be returned even to a position other than the car station is suppressed.

The car sharing system and the geofence setting method according to the present disclosure have an effect that the geofence corresponding to the car station can be appropriately set.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a car sharing system according to Embodiment 1;

FIG. 2A is a perspective view showing an outdoor parking lot in which a car station according to Embodiment 1 is provided;

FIG. 2B is a diagram showing a state in which a geofence is set in a narrow range so as to surround the car station;

FIG. 2C is a diagram showing a state in which a geofence is set by expanding the range up to an entrance and exit of the outdoor parking lot;

FIG. 3 is a flowchart showing an example of geofence setting control performed by a controller of a geofence device according to Embodiment 1;

FIG. 4A is a perspective view showing a building in which a car station is provided in a parking lot that is located indoors;

FIG. 4B is a perspective view showing a building in which a car station is provided in a parking lot under the ground;

FIG. 4C is a diagram showing a state in which a geofence is expanded up to an entrance and exit of the building;

FIG. 5 is a flowchart showing an example of geofence setting control performed by a controller of a geofence device according to Embodiment 2;

FIG. 6A is a diagram showing a state in which portions of geofences, each corresponding to each of a plurality of car stations, overlap with each other;

FIG. 6B is a diagram showing a state in which the geofences, each corresponding to each of the car stations, do not overlap with each other;

FIG. 7 is a flowchart showing an example of geofence setting control performed by a controller of a geofence device according to Embodiment 3;

FIG. 8A is a diagram showing a state in which a vehicle return position other than the car station where the vehicle could be returned is included in the geofence;

FIG. 8B is a diagram showing a state in which the vehicle return position other than the car station where the vehicle could be returned is not included in the geofence;

FIG. 9 is a flowchart showing an example of geofence setting control performed by a controller of a geofence device according to Embodiment 4; and

FIG. 10 is a flowchart showing an example of geofence setting control performed by a controller of a geofence device according to Embodiment 5.

### DETAILED DESCRIPTION OF EMBODIMENTS

### Embodiment 1

Hereinafter, Embodiment 1 of the car sharing system and the geofence setting method according to the present disclosure will be described. The present disclosure is not limited to the present embodiment.

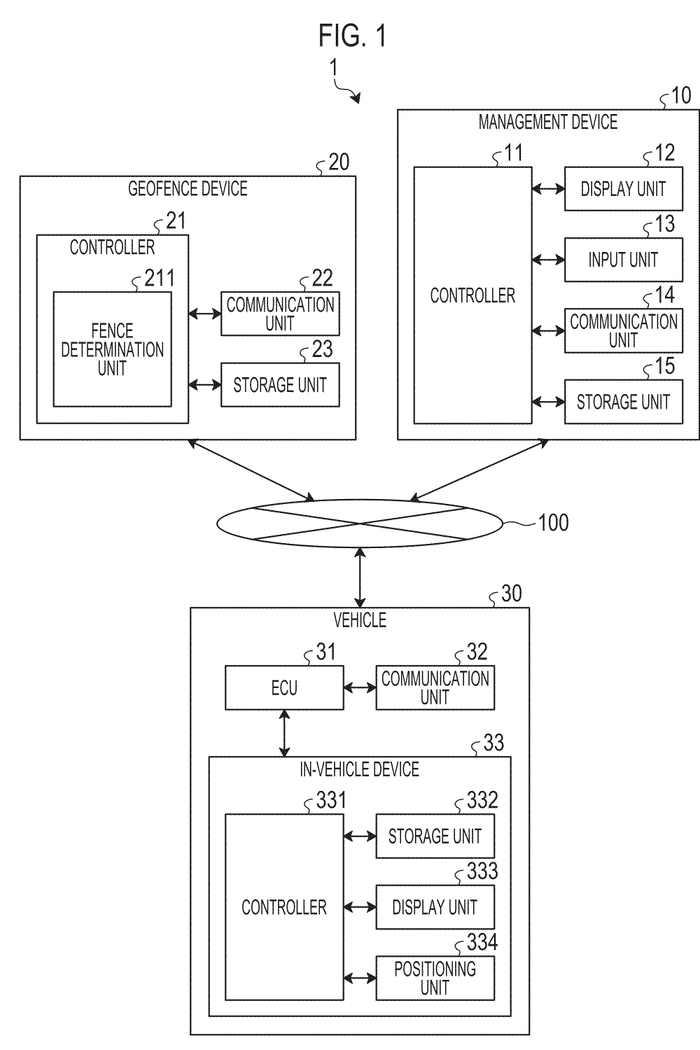

FIG. 1 is a diagram showing a schematic configuration of a car sharing system according to Embodiment 1.

As shown in FIG. 1, the car sharing system 1 according to the embodiment is configured by a management device 10, a geofence device 20, a vehicle 30, and the like. In addition, in FIG. 1, solely one vehicle 30 is shown, but the vehicle 30 may be a plurality of vehicles.

The management device 10, the geofence device 20, and the vehicle 30 all include a communication function and are configured to communicate with each other through a network 100. The network 100 is configured by, for example, a public communication network such as an Internet line network or a mobile telephone network.

The management device 10 is a device for performing processing related to management of a car sharing service in which the vehicle 30 that is jointly used among members registered in advance is rented out and returned to a car station. The management device 10 is realized by, for example, a general-purpose computer such as a workstation or a personal computer.

As shown in FIG. 1, the management device 10 includes a controller 11, a display unit 12, an input unit 13, a communication unit 14, and a storage unit 15. The controller 11 includes, for example, a processor such as a central processing unit (CPU) and a memory (main storage unit) consisting of a random access memory (RAM), a read only memory (ROM), and the like. The controller 11 loads and executes a program stored in the storage unit 15 in a work area of the memory (main storage unit) and controls each configuration unit and the like through the execution of the program to realize a function that matches a predetermined purpose.

The display unit 12 is configured by, for example, a liquid crystal display (LCD), an organic EL display (OLED), or the like, and based on control by the controller 11, displays various types of information for reference by an administrator. It should be noted that the term "administrator" refers to a person who manages the car sharing service.

The input unit 13 is configured by a touch panel or the like having an input function of receiving an operation by a finger, a pen, or the like of the administrator.

In the present embodiment, the display unit 12 and the input unit 13 are integrally configured by a touch panel display or the like. The touch panel display has a display function of displaying various types of information based on the control by the controller 11, and an input function of receiving an operation by a finger, a pen, or the like of the administrator.

The communication unit 14 is configured by, for example, a local area network (LAN) interface board, a wireless communication circuit for wireless communication, and the like. The communication unit 14 is connected to the network 100 by wire or wirelessly and performs communication between the geofence device 20 and the vehicle 30.

The storage unit 15 is configured by a recording medium such as a hard disk drive (HDD). The storage unit 15 is configured to store an operating system (OS), various programs, various tables, various databases, and the like. In addition, the storage unit 15 stores, for example, fence setting information including information related to a range of the geofence and the like. In addition, the storage unit 15 stores vehicle position information and the like as necessary in addition to the fence setting information through the network 100.

The geofence device 20 is a device for performing processing related to a geofence for setting a returnable range of the vehicle 30 for a car station where the vehicle 30 is rented out and returned. The geofence device 20 is realized by, for example, a general-purpose computer such as a workstation or a personal computer.

As shown in FIG. 1, the geofence device 20 includes a controller 21, a communication unit 22, and a storage unit 23. The controller 21 functions as a fence determination unit 211 through the execution of a program stored in the storage unit 23. The communication unit 22 can perform communication with the management device 10 and the vehicle 30 by being connected to the network 100 by wire or wirelessly. In addition, the storage unit 23 stores, for example, fence information including a range in which the geofence is set for the car station. The controller 21 transmits, for example, the fence information stored in the storage unit 23 to the management device 10 through the network 100 from the communication unit 22.

The fence determination unit 211 determines, for example, whether the vehicle 30 has entered the geofence set for the car station as a return destination. The fence determination unit 211 acquires, via the communication unit 22 through the network 100, position information of the vehicle 30 (hereinafter, referred to as "vehicle position information") from the vehicle 30. Subsequently, the fence determination unit 211 determines, based on the vehicle position information and the fence information stored in the storage unit 23, whether the vehicle 30 has entered the geofence set for the car station as the return destination. Then, the fence determination unit 211 outputs fence determination information that is information related to whether the vehicle 30 has entered the geofence, to the management device 10 through the network 100 from the communication unit 22. When the vehicle 30 has entered the geofence and when the vehicle 30 has exited the geofence, the fence determination unit 211 transmits the fence determination information indicating the fact to the management device 10.

The vehicle 30 is a car sharing vehicle that is jointly used among members registered in advance for the car sharing service. The vehicle 30 is a movable object that is communicable with the outside and may be an electrified vehicle such as a hybrid electric vehicle or a plug-in hybrid electric vehicle. In addition, the vehicle 30 may be either a manually driven vehicle or an automated driving vehicle.

As shown in FIG. 1, the vehicle 30 includes an electronic control unit (ECU) 31, a communication unit 32, and an in-vehicle device 33. The ECU 31 comprehensively controls the operations of various components mounted in the vehicle 30. The communication unit 32 is configured by, for example, a data communication module (DCM) or the like. The communication unit 32 can perform communication with the management device 10 and the geofence device 20 via wireless communication through the network 100.

The in-vehicle device 33 includes a controller 331, a storage unit 332, a display unit 333, and a positioning unit 334. The controller 331 controls the display unit 333, the positioning unit 334, and the like through the execution of a program stored in the storage unit 332.

The display unit 333 is configured by, for example, a liquid crystal display (LCD), an organic EL display (OLED), or the like, and displays various types of information to a user based on the control by the controller 331. It should be noted that the term "user" refers to an occupant of the vehicle 30 including a driver. In addition, the display unit 333 may be configured by a touch panel display or the like having an input function of receiving an operation by a finger, a pen, or the like of the user and a display function of displaying various types of information based on the control by the controller 331.

The positioning unit 334 receives radio waves from a global positioning system (GPS) satellite and detects the vehicle position information. The positioning unit 334, controlled by the controller 331, outputs the detected vehicle position information to the management device 10 and the geofence device 20 through the network 100 from the communication unit 32.

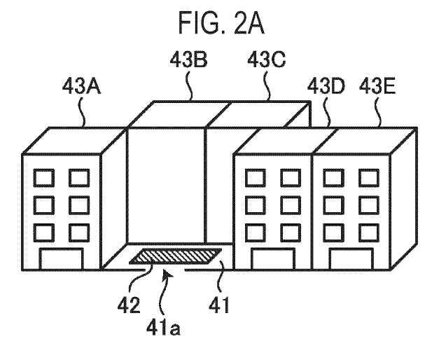

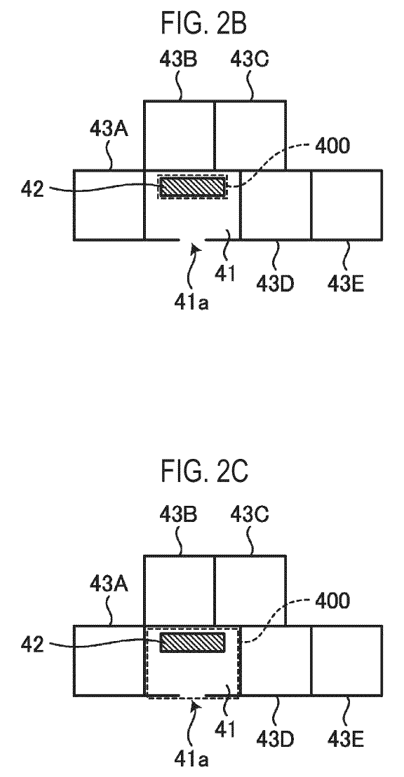

FIG. 2A is a perspective view showing an outdoor parking lot 41 in which a car station 42 according to Embodiment 1 is provided. FIG. 2B is a diagram showing a state in which a geofence 400 is set in a narrow range so as to surround the car station 42. FIG. 2C is a diagram showing a state in which the geofence 400 is set by expanding the range up to an entrance and exit 41a of the outdoor parking lot 41.

In the car sharing system 1 according to Embodiment 1, as shown in FIG. 2A, the car station 42 is provided in the outdoor parking lot 41 in an urban area in which high-rise buildings 43A, 43B, 43C, 43D, 43E are lined up. In the following description, the high-rise buildings 43A, 43B, 43C, 43D, 43E are simply referred to as a high-rise building 43 when the high-rise buildings 43A, 43B, 43C, 43D, 43E are not particularly distinguished from each other.

As shown in FIG. 2B, the outdoor parking lot 41 has a rectangular shape as viewed from above, the high-rise building 43A is adjacent to one short side, and the high-rise building 43D is adjacent to the other short side. In addition, a road faces one long side of the outdoor parking lot 41, and an entrance and exit 41a for the vehicle 30 to enter and exit between the outdoor parking lot 41 and the road is provided. The high-rise buildings 43B, 43C are adjacent to the other long side of the outdoor parking lot 41. As described above, the outdoor parking lot 41 and the car station 42 are surrounded, in a predetermined ratio, by the high-rise building 43.

As shown in FIG. 2B, a geofence 400 indicating a returnable range of the vehicle 30 is set in the car station 42 provided in the outdoor parking lot 41 so as to surround the car station 42. In the car sharing system 1 according to Embodiment 1, when the vehicle 30 is within the geofence 400, the return of the vehicle 30 is completed when the user performs the return operation of the vehicle 30.

Here, in the car sharing system 1 according to Embodiment 1, the positioning unit 334 (GPS) of the vehicle 30 functions as a position information acquisition device that acquires the position information of the vehicle 30 that is jointly used among the users registered in advance. In addition, the storage unit 23 of the geofence device 20 functions as a storage device that stores map information including three-dimensional data of a building such as the high-rise building 43 positioned around the car station 42 where the vehicle 30 is rented out and returned. In addition, the controller 21 of the geofence device 20 functions as a control device that sets the geofence 400 corresponding to the returnable range of the vehicle 30 for the car station 42.

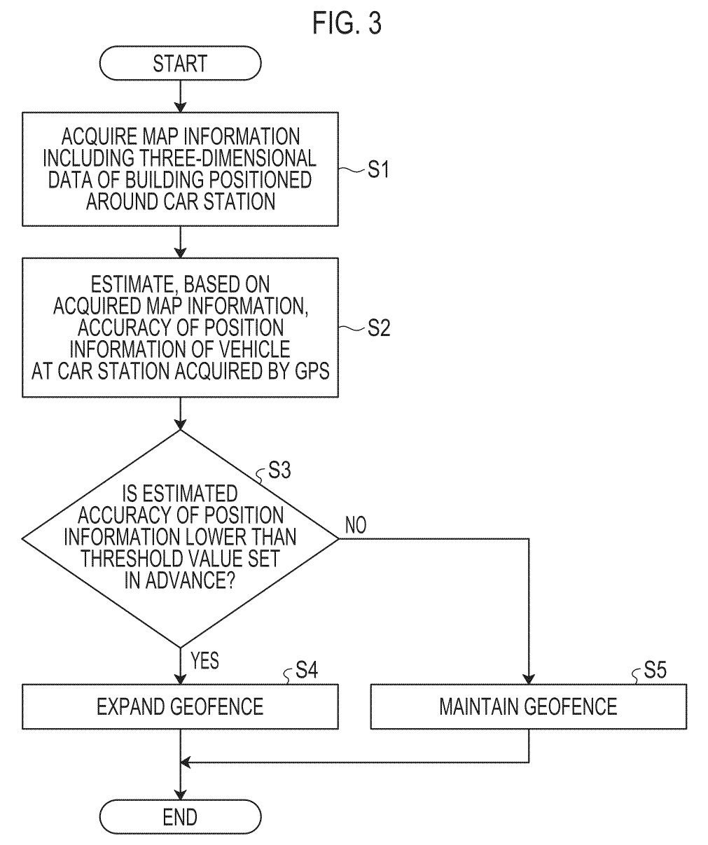

FIG. 3 is a flowchart showing an example of geofence setting control performed by a controller 21 of a geofence device 20 according to Embodiment 1.

First, the controller 21 of the geofence device 20 acquires the map information including the three-dimensional data of the building positioned around the car station 42 as the return destination from the storage unit 23 of the geofence device 20 (S1). Next, the controller 21 of the geofence device 20 estimates, based on the acquired map information, the accuracy of the position information of the vehicle 30 at the car station 42, the position information being acquired by GPS (S2). Next, the controller 21 of the geofence device 20 determines whether the estimated accuracy of the position information of the vehicle 30 is lower than the threshold value set in advance (S3). When the controller 21 of the geofence device 20 determines that the estimated accuracy of the position information of the vehicle 30 is lower than the threshold value set in advance (YES in S3) because the car station 42 is surrounded, in a predetermined ratio, by the high-rise building 43 that is a building with a height equal to or greater than a predetermined height, the geofence 400 corresponding to the car station 42 is expanded up to the entrance and exit 41a of the outdoor parking lot 41 (S4). For example, the controller 21 of the geofence device 20 performs control to expand the geofence 400 up to the entrance and exit 41a by using the information of the entrance and exit 41a of the outdoor parking lot 41 included in the map information, or by identifying the entrance and exit 41a of the outdoor parking lot 41 from the map information. Thereafter, the controller 21 of the geofence device 20 ends the series of geofence setting controls. On the other hand, when the controller 21 of the geofence device 20 determines that the car station 42 is not surrounded, in a predetermined ratio, by the high-rise building 43 that is a building with a height equal to or greater than a predetermined height, and the estimated accuracy of the position information of the vehicle 30 is not lower than the threshold value set in advance (NO in S3), the geofence 400 corresponding to the car station 42 is maintained (S5). Thereafter, the controller 21 of the geofence device 20 ends the series of geofence setting controls.

In the car sharing system 1 according to Embodiment 1, as the geofence setting method, when the car station 42 is surrounded, in a predetermined ratio, by the high-rise building 43, the geofence 400 is expanded up to the entrance and exit 41a of the outdoor parking lot 41 as shown in FIG. 2C. As a result, the fence determination unit 210 of the geofence device 20 can determine that the vehicle 30 has entered the geofence 400 by the vehicle 30 entering the outdoor parking lot 41 from the entrance and exit 41a even in a case where the accuracy of the GPS of the car station 42 is low. Then, the controller 11 of the management device 10 can determine that the return determination of the vehicle 30 is OK by estimating, based on the fence determination information acquired from the fence determination unit 210 of the geofence device 20, that the vehicle 30 has been returned to the car station 42. Therefore, in the car sharing system 1 according to Embodiment 1, the return of the vehicle 30 by the user can be completed even in a case where the car station 42 is provided in the outdoor parking lot 41 where the accuracy of the GPS is low due to being surrounded, in a predetermined ratio, by the high-rise building 43.

When the car station 42 is surrounded, in a predetermined ratio, by the high-rise building 43 based on the map information or the like, information recommending the expansion of the geofence 400 may be displayed on the display unit 12 of the management device 10 to notify the administrator. Then, the administrator may expand the geofence 400 up to the entrance and exit 41a of the outdoor parking lot 41 in which the car station 42 is provided by an operation on the input unit 13 of the management device 10 and set the geofence 400.

### Embodiment 2

Hereinafter, Embodiment 2 of the car sharing system and the geofence setting method according to the present disclosure will be described. It should be noted that the same description as that of Embodiment 1 will be appropriately omitted in the present embodiment.

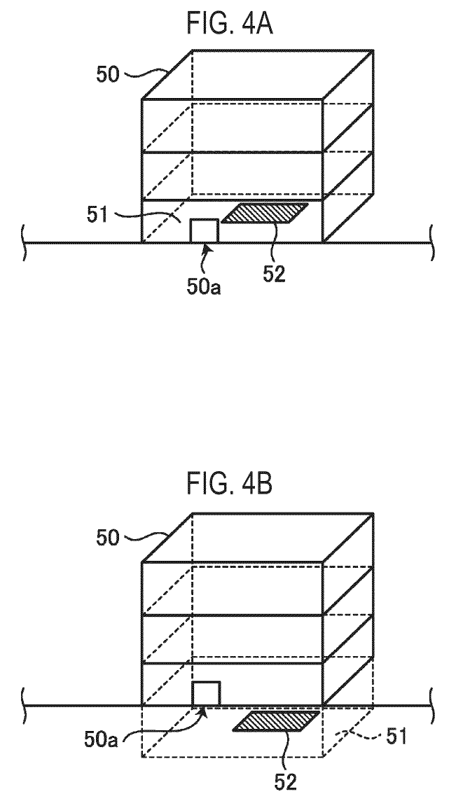

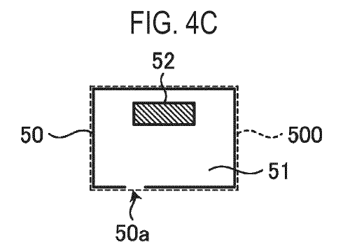

FIG. 4A is a perspective view showing a building 50 in which a car station 52 is provided in a parking lot 51 that is located indoors. FIG. 4B is a perspective view showing a building 50 in which a car station 52 is provided in a parking lot 51 under the ground. FIG. 4C is a diagram showing a state in which a geofence 500 is expanded up to an entrance and exit 50a of the building 50.

In the car sharing system 1 according to Embodiment 2, as shown in FIGS. 4A and 4B, the car station 52 is provided in the parking lot 51 that is located indoors or underground in the building 50. The vehicle 30 enters and exits the car station 52 through the entrance and exit 50a of the building 50. That is, the entrance and exit 50a of the building 50 also serves as an entrance and exit of the parking lot 51 that is located indoors or underground, and hence also the entrance and exit of the car station 52.

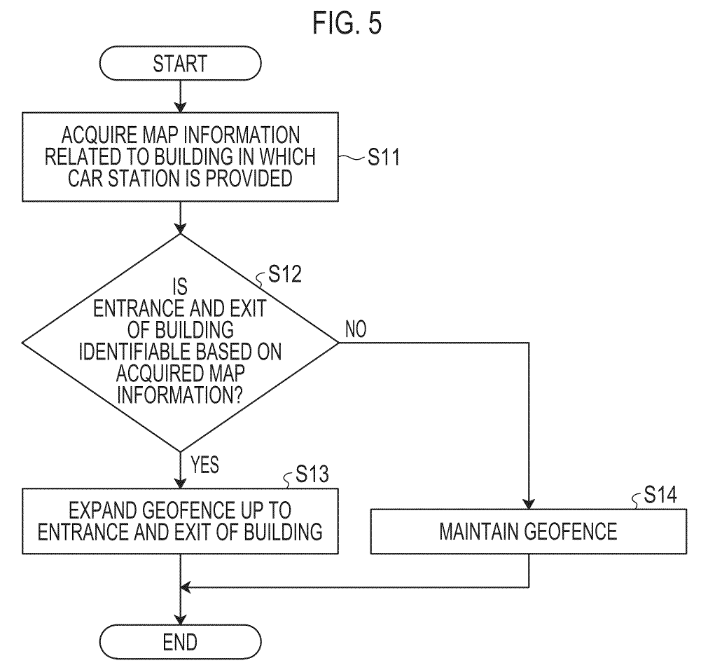

FIG. 5 is a flowchart showing an example of geofence setting control performed by a controller 21 of a geofence device 20 according to Embodiment 2.

First, the controller 21 of the geofence device 20 acquires from the storage unit 23 of the geofence device 20, the map information related to the building 50 in which the car station 52 is provided (S11). Next, the controller 21 of the geofence device 20 determines whether the entrance and exit 50a of the building 50 is identifiable based on the acquired map information (S12). When the controller 21 of the geofence device 20 determines that the entrance and exit 50a of the building 50 is identifiable based on the acquired map information (YES in S12), the geofence 500 corresponding to the car station 52 is expanded up to the entrance and exit 50a (S13). For example, the controller 21 of the geofence device 20 performs control to expand the geofence 500 up to the entrance and exit 50a by using the information of the entrance and exit 50a of the building 50 included in the map information, or by identifying the entrance and exit 50a of the building 50 from the map information. Thereafter, the controller 21 of the geofence device 20 ends the series of geofence setting controls. On the other hand, when the controller 21 of the geofence device 20 determines that the entrance and exit 50a of the building 50 is not identifiable based on the acquired map information (NO in S12), the geofence 500 corresponding to the car station 52 is maintained (S14). Thereafter, the controller 21 of the geofence device 20 ends the series of geofence setting controls.

As described above, in the car sharing system 1 according to Embodiment 2, as the geofence setting method, the geofence 500 that is the returnable range of the vehicle 30 is expanded up to the entrance and exit 50a of the building 50 in which the car station 52 is provided. As a result, the fence determination unit 210 of the geofence device 20 can determine that the vehicle 30 has entered the geofence 500 by the vehicle 30 entering the building 50 from the entrance and exit 50a even in a case where the acquisition of the position information of the vehicle 30 by GPS is difficult. Then, the controller 11 of the management device 10 can determine that the return determination of the vehicle 30 is OK by estimating, based on the fence determination information acquired from the fence determination unit 210 of the geofence device 20, that the vehicle 30 has been returned to the car station 52. Therefore, in the car sharing system 1 according to Embodiment 2, the return of the vehicle 30 can be completed by the return operation of the user even in a case where the car station 52 is provided in the parking lot 51 that is located indoors or underground in which the acquisition of the position information of the vehicle 30 by GPS is difficult.

When the car station 52 is provided in the parking lot 51 that is located indoors or underground in the building 50, information recommending the expansion of the geofence 500 may be displayed on the display unit 12 of the management device 10 to notify the administrator. Then, the administrator may expand the geofence 500 up to the entrance and exit 50a of the building 50 in which the car station 52 is provided by an operation on the input unit 13 of the management device 10 and set the geofence 500.

and exit 50a of the building 50 in which the car station 52 is provided by an operation on the input unit 13 of the management device 10, and set the geofence 500.

### Embodiment 3

Hereinafter, Embodiment 3 of the car sharing system and the geofence setting method according to the present disclosure will be described. It should be noted that the same description as that of Embodiment 1 will be appropriately omitted in the present embodiment.

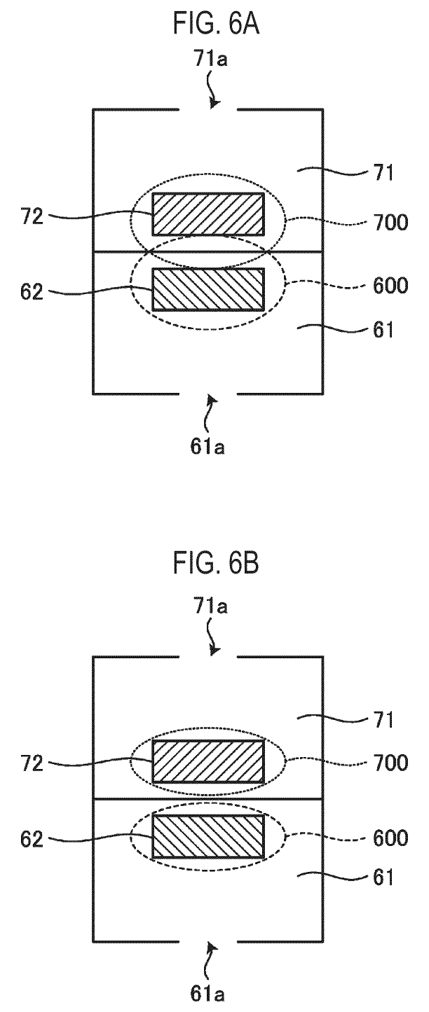

FIG. 6A is a diagram showing a state in which portions of geofences 600, 700, each corresponding to each of a plurality of car stations 62, 72, overlap with each other. FIG. 6B is a diagram showing a state in which the geofences 600, 700, each corresponding to each of the plurality of car stations 62, 72, do not overlap with each other.

In the car sharing system 1 according to Embodiment 3, as shown in FIG. 6A, the car stations 62, 72 are each provided in each of a plurality of adjacent ground parking lots 61, 71. The ground parking lots 61, 71 have a rectangular shape as viewed from above, and are adjacent to each other on a long side that is a boundary between the ground parking lots 61, 71. The car stations 62, 72 are provided in the ground parking lots 61, 71 by being positioned in the vicinity of the long side that is a boundary between the ground parking lots 61, 71. In addition, the ground parking lots 61, 71 are each provided with an entrance and exit 61a or 71a on a long side that is on the opposite side of the boundary from the ground parking lots 61, 71, through which the vehicle 30 enters and exits the ground parking lots 61, 71. In addition, as shown in FIG. 6A, the geofences 600, 700 that are the returnable ranges of the vehicle 30, each corresponding to each of the car stations 62, 72, partially overlap with each other.

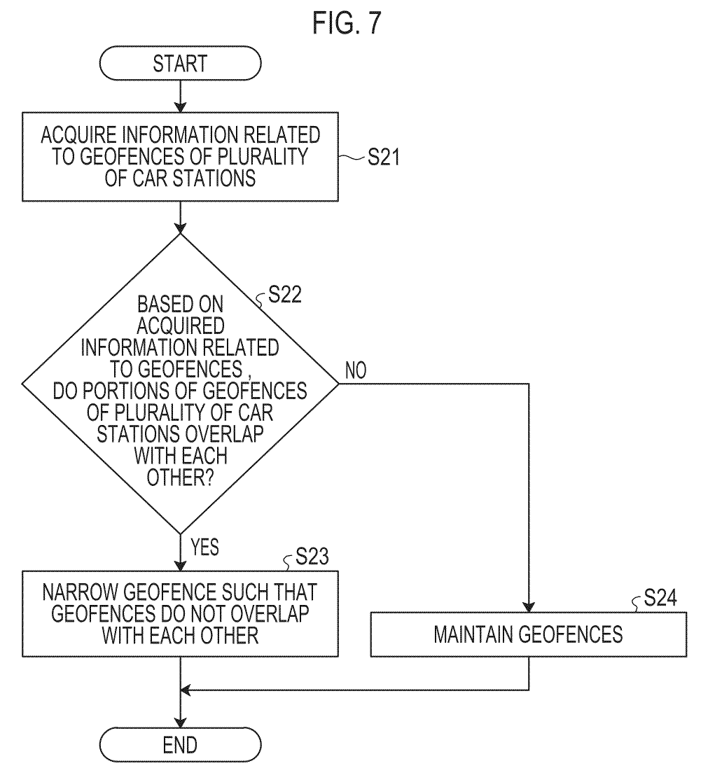

FIG. 7 is a flowchart showing an example of geofence setting control performed by the controller 21 of the geofence device 20 according to Embodiment 3.

First, the controller 21 of the geofence device 20 acquires from the storage unit 23 of the geofence device 20, information (fence information) related to the geofences 600, 700, each corresponding to each of the car stations 62, 72 (S21). Next, the controller 21 of the geofence device 20 determines whether portions of the geofences 600, 700 of the car stations 62, 72 overlaps with each other based on the acquired information (fence information) related to the geofences 600, 700 (S22). When the controller 21 of the geofence device 20 determines that portions of the geofences 600, 700 overlaps with each other (YES in S22), at least one of the geofences 600, 700 is narrowed such that the geofences 600, 700 do not overlap with each other (S23). Then, the controller 21 of the geofence device 20 ends the series of geofence setting controls. On the other hand, when the controller 21 of the geofence device 20 determines that portions of the geofences 600, 700 do not overlap with each other (NO in S22), the geofences 600, 700 are maintained (S24). Thereafter, the controller 21 of the geofence device 20 ends the series of geofence setting controls.

In the car sharing system 1 according to Embodiment 3, as the geofence setting method, when portions of the geofences 600, 700 overlaps with each other, at least one of the geofences 600, 700 is narrowed such that the geofences 600, 700 do not overlap with each other, as shown in FIG. 6B. In FIG. 6B, the geofences 600, 700 of the car stations 62, 72 are both narrowed such that portions of the geofences 600, 700 do not overlap with each other. As a result, in the car sharing system 1 according to Embodiment 3, it is possible to suppress a situation in which the vehicle 30 can be returned to a car station that is unintended by the user. For example, in a case of a one-way car sharing service, it is possible to suppress a situation in which the vehicle 30 can be returned to a car station that is unintended by the user. In the one-way car sharing service, the car station where the vehicle 30 is rented out and the car station where the vehicle 30 is returned are different.

When portions of the geofences 600, 700 overlaps with each other, information recommending the narrowing of at least one of the geofences 600, 700 may be displayed on the display unit 12 of the management device 10 to notify the administrator. Then, the administrator may narrow at least one of the geofences 600, 700 such that portions of the geofences 600, 700 do not overlap with each other by an operation on the input unit 13 of the management device 10, and set the geofences 600, 700.

### Embodiment 4

Hereinafter, Embodiment 4 of the car sharing system and the geofence setting method according to the present disclosure will be described. It should be noted that the same description as that of Embodiment 1 will be appropriately omitted in the present embodiment.

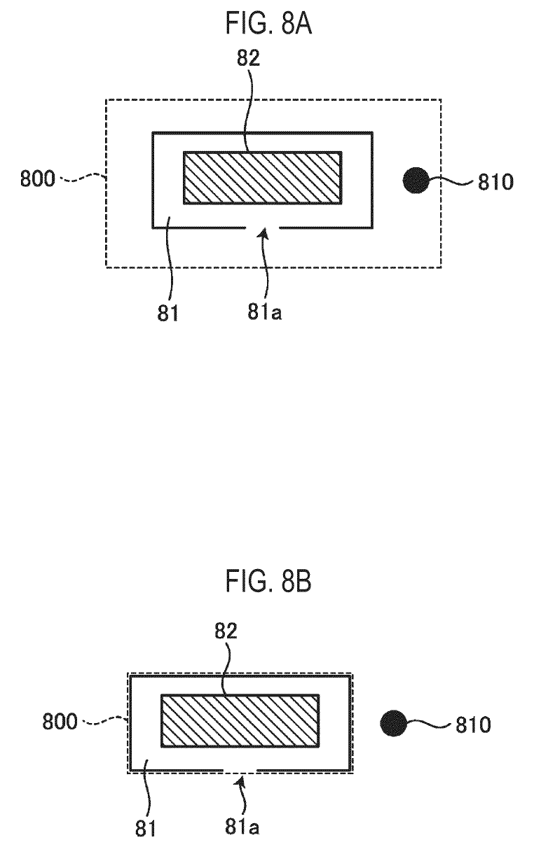

FIG. 8A is a diagram showing a state in which a vehicle return position 810 other than the car station 82 where the vehicle 30 could be returned is included in the geofence 800. FIG. 8B is a diagram showing a state in which the vehicle return position 810 other than the car station 82 where the vehicle 30 could be returned is not included in the geofence 800.

In the car sharing system 1 according to Embodiment 4, as shown in FIG. 8A, the car station 82 is provided in a parking lot 81. The parking lot 81 has a rectangular shape as viewed from above, and an entrance and exit 81a for the vehicle 30 to enter and exit the outdoor parking lot 41 is provided on one long side. In addition, as shown in FIG. 8A, the geofence 800 corresponding to the returnable range of the vehicle 30 for the car station 82 is set to a range wider than the parking lot 81. Therefore, in FIG. 8A, even though the actual vehicle return position 810 at the time of return of the vehicle is a position other than the car station 82, there is a case in which the vehicle 30 could be returned to the car station 82.

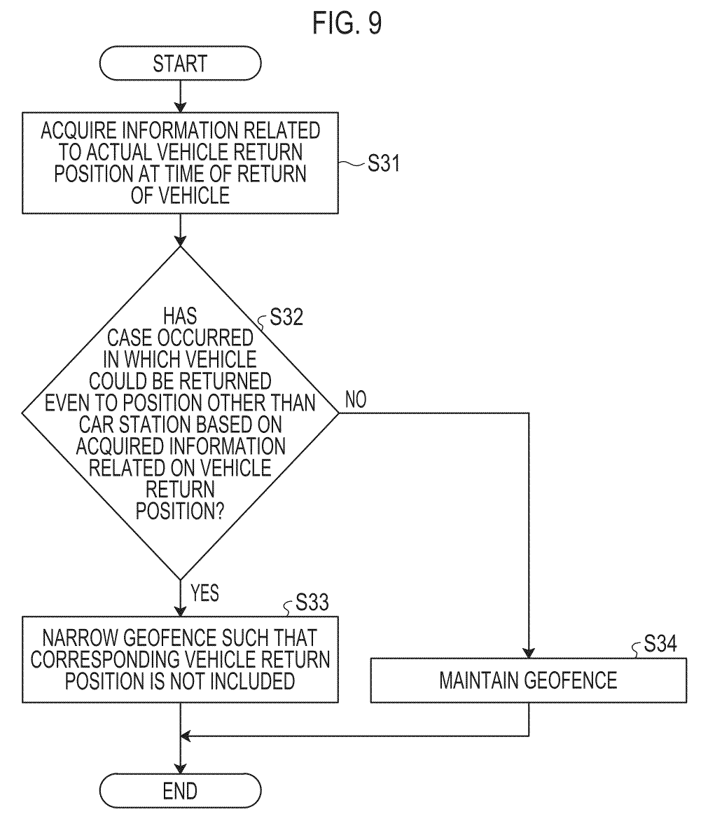

FIG. 9 is a flowchart showing an example of geofence setting control performed by the controller 21 of the geofence device 20 according to Embodiment 4.

First, the controller 21 of the geofence device 20 acquires information related to the actual vehicle return position at the time of return of the vehicle (S31). Next, the controller 21 of the geofence device 20 determines, based on the acquired information related to the vehicle return position, whether a case has occurred in which the vehicle 30 could be returned even to a position other than the car station 82 as the return destination (S32). When the controller 21 of the geofence device 20 determines that a case has occurred in which the vehicle 30 could be returned to a position other than the car station 82 (YES in S32), the geofence 800 corresponding to the car station 82 is narrowed such that the corresponding vehicle return position 810 is not included (S33). Thereafter, the controller 21 of the geofence device 20 ends the series of geofence setting controls. On the other hand, when the controller 21 of the geofence device 20 determines that a case has not occurred in which the vehicle 30 could be returned to a position other than the car station 82 (NO in S32), the geofence 800 for the car station 82 is maintained (S34). Thereafter, the controller 21 of the geofence device 20 ends the series of geofence setting controls.

In the car sharing system 1 according to Embodiment 4, as the geofence setting method, as shown in FIG. 8B, the geofence 800 is narrowed such that the vehicle return position 810 corresponding to the case where the vehicle 30 could be returned even to a position other than the car station 82 is not included. As a result, in the car sharing system 1 according to Embodiment 4, it is possible to suppress a situation in which the vehicle 30 can be returned (that the return of the vehicle 30 can be completed) even to a position other than the car station 82.

When the case has occurred in which the vehicle 30 can be returned even to a position other than the car station 82, there is a case where the next user (customer) contacts the administrator to report that the vehicle 30 has not been returned to the designated place. In this case, the vehicle return position 810 where the vehicle 30 could be returned even to a position other than the car station 82 may be displayed on the display unit 12 of the management device 10 in a state of being overlaid on the map information or the geofence 800, and the administrator may set the geofence 800 using the management device 10. That is, the administrator may operate the input unit 13 of the management device 10 to narrow and set the geofence 800 such that the vehicle return position 810 displayed on the display unit 12 of the management device 10 is not included (such that the vehicle return position 810 is outside the geofence 800).

### Embodiment 5

Hereinafter, Embodiment 5 of the car sharing system and the geofence setting method according to the present disclosure will be described. It should be noted that the same description as that of Embodiment 1 will be appropriately omitted in the present embodiment.

In the car sharing system 1 according to Embodiment 5, after the operation start of the car sharing service, actual vehicle position information at the time of return of the vehicle within a predetermined period is collected. Then, when the variation in the vehicle position information is large, the geofence corresponding to the returnable range of the vehicle 30 for the car station as the return destination is expanded.

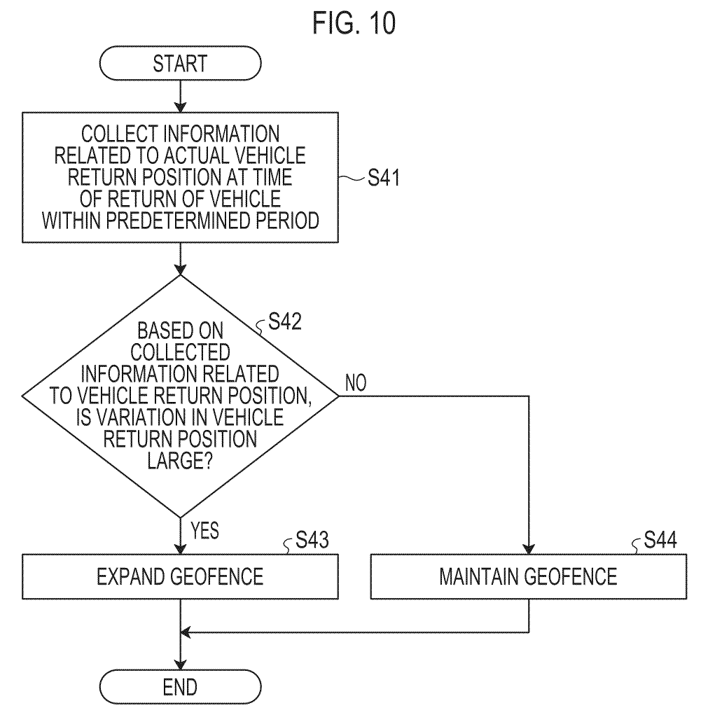

FIG. 10 is a flowchart showing an example of geofence setting control performed by the controller 21 of the geofence device 20 according to Embodiment 5.

First, the controller 21 of the geofence device 20 collects information related to the actual vehicle return position at the time of return of the vehicle within the predetermined period (S41). Next, the controller 21 of the geofence device 20 determines, based on the collected information related to the vehicle return position, whether the variation in the vehicle return position is large (S42). For example, the controller 21 of the geofence device 20 determines, based on a threshold value set in advance, whether the variation in the vehicle return position is large or small. When the controller 21 of the geofence device 20 determines that the variation in the vehicle return position is large (YES in S42), the geofence corresponding to the car station as the return destination is expanded (S43). Thereafter, the controller 21 of the geofence device 20 ends the series of geofence setting controls. On the other hand, when the controller 21 of the geofence device 20 determines that the variation in the vehicle return position is small (NO in S42), the geofence corresponding to the car station is maintained (S44). Thereafter, the controller 21 of the geofence device 20 ends the series of geofence setting controls.

In the car sharing system 1 according to Embodiment 5, when the variation in the vehicle return position is large, the geofence corresponding to the car station is expanded. As a result, in the car sharing system 1 according to Embodiment 5, the variation in the vehicle return position when returning the vehicle 30 to the car station as the return destination can be made small.

What is claimed is:

1. A car sharing system comprising:
a position information acquisition device configured to acquire position information of a vehicle that is jointly used among users registered in advance;
a storage device configured to store map information including three-dimensional data of a building positioned around a car station where the vehicle is rented out and returned; and
a control device configured to set a geofence that is a returnable range of the vehicle and that corresponds to the car station,
wherein the control device is configured to acquire the map information from the storage device, and is configured to execute control to expand the geofence, when an accuracy of the position information at the car station, the position information being acquired by the position information acquisition device, is estimated to be lower than a threshold value set in advance, based on the map information that is acquired, because the car station is surrounded, in a predetermined ratio, by the building with a height equal to or greater than a predetermined height.

2. A geofence setting method comprising estimating, based on map information including three-dimensional data of a building positioned around a car station where a vehicle that is jointly used among users registered in advance is rented out and returned, an accuracy of position information of the vehicle acquired by GPS at the car station, and expanding, when the accuracy of the position information is estimated to be lower than a threshold value set in advance, a geofence that is a returnable range of the vehicle and that corresponds to the car station.

3. A geofence setting method comprising narrowing, when portions of a plurality of geofences overlap with each other, at least one of the geofences such that the geofences do not overlap with each other, the geofences being each a returnable range of a vehicle jointly used among users registered in advance and each corresponding to one of a plurality of car stations where the vehicle is rented out and returned.
